(19) United States
(12) Patent Application Publication
(10) Pub. No.: US 2015/0304965 A1
(43) Pub. Date: Oct. 22, 2015

(54) METHOD FOR TRANSMITTING POWER HEADROOM REPORT TO NETWORK AT USER EQUIPMENT IN WIRELESS COMMUNICATION SYSTEM AND AN APPARATUS THEREFOR

(71) Applicant: LG ELECTRONICS INC., Seoul (KR)

(72) Inventors: Sungjun PARK, Anyang-si, Gyeonggi-do (KR); Seungjune YI, Anyang-si, Gyeonggi-do (KR); Youngdae LEE, Anyang-si, Gyeonggi-do (KR); Sunghoon JUNG, Anyang-si, Gyeonggi-do (KR); Sunyoung LEE, Anyang-si, Gyeonggi-do (KR)

(73) Assignee: LG ELECTRONICS INC., Seoul (KR)

(21) Appl. No.: 14/423,399

(22) PCT Filed: Oct. 25, 2013
(86) PCT No.: PCT/KR2013/009580

§ 371 Date: Feb. 23, 2015

Related U.S. Application Data
(60) Provisional application No. 61/721,497, filed on Nov. 2, 2012.

(51) Int. Cl. H04W 52/36; H04L 5/00

(52) U.S. Cl. CPC H04W 52/365; H04L 5/0053

(57) ABSTRACT

A method for processing a signal at a user equipment in a wireless communication system is disclosed. The method includes steps of constructing a PHR (Power Headroom Report) MAC (Medium Access Control) control element for at least one cell; reconstructing the PHR MAC control element by replacing information on the transmission power of the at least one cell with padding bits, if an indication indicating that a transmission of the at least one cell does not occur is received from a network; and transmitting the PHR MAC control element to the network.

### TECHNICAL FIELD

The present invention relates to a wireless communication system and, more particularly, to a method for transmitting power headroom report to a network at a user equipment in a wireless communication system and an apparatus therefor.

### BACKGROUND ART

As an example of a mobile communication system to which the present invention is applicable, a 3rd Generation Partnership Project Long Term Evolution (hereinafter, referred to as LTE) communication system is described in brief.

FIG. 1 is a view schematically illustrating a network structure of an E-UMTS as an exemplary radio communication system. An Evolved Universal Mobile Telecommunications System (E-UMTS) is an advanced version of a conventional Universal Mobile Telecommunications System (UMTS) and basic standardization thereof is currently underway in the 3GPP. E-UMTS may be generally referred to as a Long Term Evolution (LTE) system. For details of the technical specifications of the UMTS and E-UMTS, reference can be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of the network (E-UTRAN) and connected to an external network. The eNBs may simultaneously transmit multiple data streams for a broadcast service, a multicast service, and/or a unicast service.

One or more cells are present per eNB. A cell is configured to use one of bandwidths of 1.44, 3, 5, 10, 15, and 20 MHz to provide a downlink or uplink transport service to several UEs. Different cells may be set to provide different bandwidths. The eNB controls data transmission and reception for a plurality of UEs. The eNB transmits downlink scheduling information with respect to downlink data to notify a corresponding UE of a time/frequency domain in which data is to be transmitted, coding, data size, and Hybrid Automatic Repeat and reQuest (HARQ)-related information. In addition, the eNB transmits uplink scheduling information with respect to uplink data to a corresponding UE to inform the UE of an available time/frequency domain, coding, data size, and HARQ-related information. An interface may be used to transmit user traffic or control traffic between eNBs. A Core Network (CN) may include the AG, a network node for user registration of the UE, and the like. The AG manages mobility of a UE on a Tracking Area (TA) basis, each TA including a plurality of cells.

Although radio communication technology has been developed up to LTE based on Wideband Code Division Multiple Access (WCDMA), demands and expectations of users and providers continue to increase. In addition, since other radio access technologies continue to be developed, new advances in technology are required to secure future competitiveness. For example, decrease of cost per bit, increase of service availability, flexible use of a frequency band, simple structure, open interface, and suitable power consumption by a UE are required.

### DISCLOSURE

### Technical Problem

Based on the above discussion, the present invention proposes a method for transmitting power headroom report to the network at the user equipment in the wireless communication system and an apparatus therefor.

### Technical Solution

In accordance with an embodiment of the present invention, a method for processing a signal at a user equipment in a wireless communication system includes constructing a PHR (Power Headroom Report) MAC (Medium Access Control) control element for at least one cell; reconstructing the PHR MAC control element by replacing information on the transmission power of the at least one cell with padding bits, if an indication indicating that a transmission of the at least one cell does not occur is received from a network; and transmitting the PHR MAC control element to the network.

Preferably, the reconstructed PHR MAC control element includes a field indicating that the information on the transmission power of the at least one cell is replaced with the padding bits. And, a size of the padding bits is same with a size of the information on the transmission power of the at least one cell.

Further, a position of the padding bits is same with a position of the information on the transmission power of the at least one cell in the PHR MAC control element. Or, the padding bits are located at an end of the PHR MAC control element.

In the other hand, reconstructing the PHR MAC control element can comprise replacing at least one field included in a octet comprising the information on the transmission power of the at least one cell with the padding bits. In this case, the reconstructed PHR MAC control element includes a field indicating that the octet is replaced with the padding bits. And, the at least one field comprises reserved bits.

Preferably, the information on the transmission power of the at least one cell is a field indicating a maximum output power of the at least one cell.

Consequently, a size of the PHR MAC control element is maintained after reconstructing.

It is to be understood that both the foregoing general description and the following detailed description of the present invention are exemplary and explanatory and are intended to provide further explanation of the invention as claimed.

### Advantageous Effects

According to embodiments of the present invention, the user equipment can efficiently transmit the power headroom report to the network in a wireless communication system.

It will be appreciated by persons skilled in the art that that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention.

In the drawings:

FIG. 1 is a diagram showing a network structure of an Evolved Universal Mobile Telecommunications System (E-UMTS) as an example of a wireless communication system.

FIG. 2 is a diagram conceptually showing a network structure of an evolved universal terrestrial radio access network (E-UTRAN).

FIG. 3 is a diagram showing a control plane and a user plane of a radio interface protocol between a UE and an E-UTRAN based on a 3rd generation partnership project (3GPP) radio access network standard.

FIG. 4 is a diagram showing physical channels used in a 3GPP system and a general signal transmission method using the same.

FIG. 5 is a diagram showing the structure of a radio frame used in a Long Term Evolution (LTE) system.

FIG. 6 is a diagram showing the concept of a carrier aggregation scheme of an LTE-A system.

FIGS. 7 and 8 are diagrams respectively showing a second downlink layer structure and a second uplink layer structure if a carrier aggregation scheme is applied.

FIG. 9 is a diagram showing the format of a PHR MAC control element.

FIG. 10 is a diagram showing an extended PHR MAC CE format.

FIG. 11 shows an example about why the pre-constructed MAC PDU needs to be reformatted.

FIG. 12 shows an example of a new extended PHR format 1.

FIG. 13 shows an example of a new extended PHR format 2.

FIG. 14 shows an example of a new extended PHR format 3.

FIG. 15 shows an example of a new extended PHR format 4.

FIG. 16 is a block diagram of a communication apparatus according to an embodiment of the present invention.

### BEST MODE

Hereinafter, structures, operations, and other features of the present invention will be readily understood from the embodiments of the present invention, examples of which are illustrated in the accompanying drawings. Embodiments described later are examples in which technical features of the present invention are applied to a 3GPP system.

Although the embodiments of the present invention are described using a long term evolution (LTE) system and a LTE-advanced (LTE-A) system in the present specification, they are purely exemplary. Therefore, the embodiments of the present invention are applicable to any other communication system corresponding to the above definition. In addition, although the embodiments of the present invention are described based on a frequency division duplex (FDD) scheme in the present specification, the embodiments of the present invention may be easily modified and applied to a half-duplex FDD (H-FDD) scheme or a time division duplex (TDD) scheme.

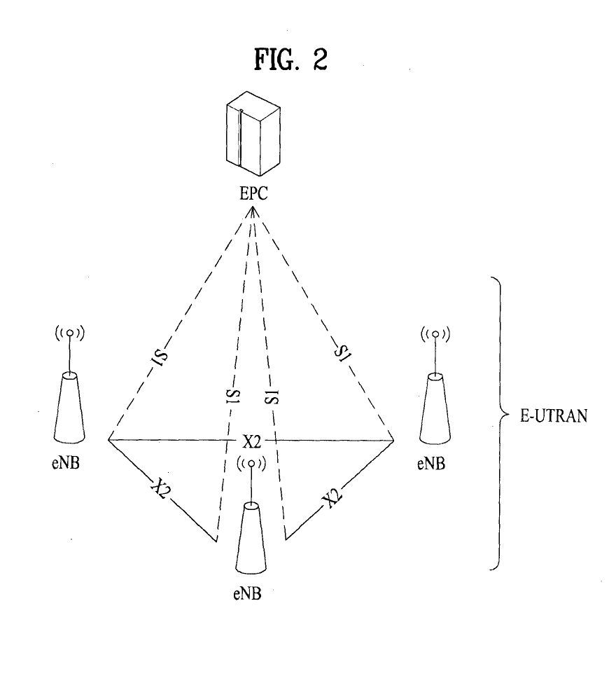

FIG. 2 is a diagram conceptually showing a network structure of an evolved universal terrestrial radio access network (E-UTRAN). An E-UTRAN system is an evolved form of a legacy UTRAN system. The E-UTRAN includes cells (eNB) which are connected to each other via an X2 interface. A cell is connected to a user equipment (UE) via a radio interface and to an evolved packet core (EPC) via an S1 interface.

The EPC includes a mobility management entity (MME), a serving-gateway (S-GW), and a packet data network-gateway (PDN-GW). The MME has information about connections and capabilities of UEs, mainly for use in managing the mobility of the UEs. The S-GW is a gateway having the E-UTRAN as an end point, and the PDN-GW is a gateway having a packet data network (PDN) as an end point.

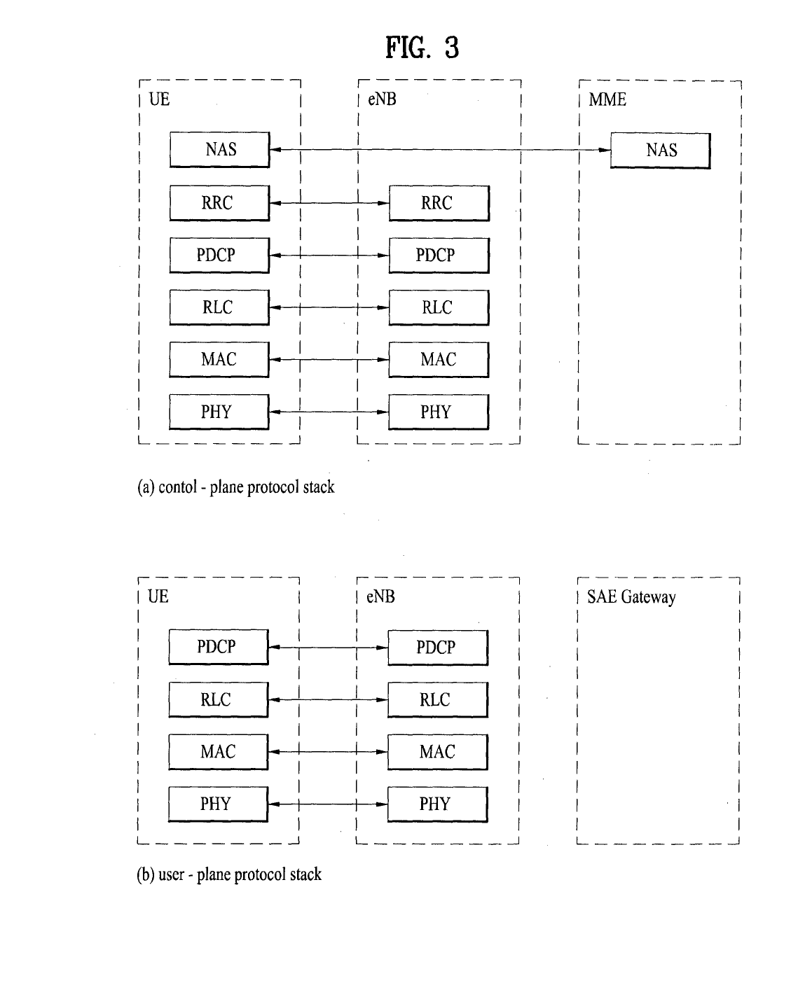

FIG. 3 is a diagram showing a control plane and a user plane of a radio interface protocol between a UE and an E-UTRAN based on a 3GPP radio access network standard. The control plane refers to a path used for transmitting control messages used for managing a call between the UE and the E-UTRAN. The user plane refers to a path used for transmitting data generated in an application layer, e.g., voice data or Internet packet data.

A physical (PHY) layer of a first layer provides an information transfer service to a higher layer using a physical channel. The PHY layer is connected to a medium access control (MAC) layer located on the higher layer via a transport channel. Data is transported between the MAC layer and the PHY layer via the transport channel. Data is transported between a physical layer of a transmitting side and a physical layer of a receiving side via physical channels. The physical channels use time and frequency as radio resources. In detail, the physical channel is modulated using an orthogonal frequency division multiple access (OFDMA) scheme in downlink and is modulated using a single carrier frequency division multiple access (SC-FDMA) scheme in uplink.

The MAC layer of a second layer provides a service to a radio link control (RLC) layer of a higher layer via a logical channel. The RLC layer of the second layer supports reliable data transmission. A function of the RLC layer may be implemented by a functional block of the MAC layer. A packet data convergence protocol (PDCP) layer of the second layer performs a header compression function to reduce unnecessary control information for efficient transmission of an Internet protocol (IP) packet such as an IP version 4 (IPv4) packet or an IP version 6 (IPv6) packet in a radio interface having a relatively small bandwidth.

A radio resource control (RRC) layer located at the bottom of a third layer is defined only in the control plane. The RRC layer controls logical channels, transport channels, and physical channels in relation to configuration, re-configuration, and release of radio bearers (RBs). An RB refers to a service that the second layer provides for data transmission between the UE and the E-UTRAN. To this end, the RRC layer of the UE and the RRC layer of the E-UTRAN exchange RRC messages with each other.

One cell of the eNB is set to operate in one of bandwidths such as 1.25, 2.5, 5, 10, 15, and 20 MHz and provides a downlink or uplink transmission service to a plurality of UEs in the bandwidth. Different cells may be set to provide different bandwidths.

Downlink transport channels for transmission of data from the E-UTRAN to the UE include a broadcast channel (BCH) for transmission of system information, a paging channel (PCH) for transmission of paging messages, and a downlink shared channel (SCH) for transmission of user traffic or control messages. Traffic or control messages of a downlink multicast or broadcast service may be transmitted through the downlink SCH and may also be transmitted through a separate downlink multicast channel (MCH).

Uplink transport channels for transmission of data from the UE to the E-UTRAN include a random access channel (RACH) for transmission of initial control messages and an uplink SCH for transmission of user traffic or control messages. Logical channels that are defined above the transport channels and mapped to the transport channels include a broadcast control channel (BCCH), a paging control channel (PCCH), a common control channel (CCCH), a multicast control channel (MCCH), and a multicast traffic channel (MTCH).

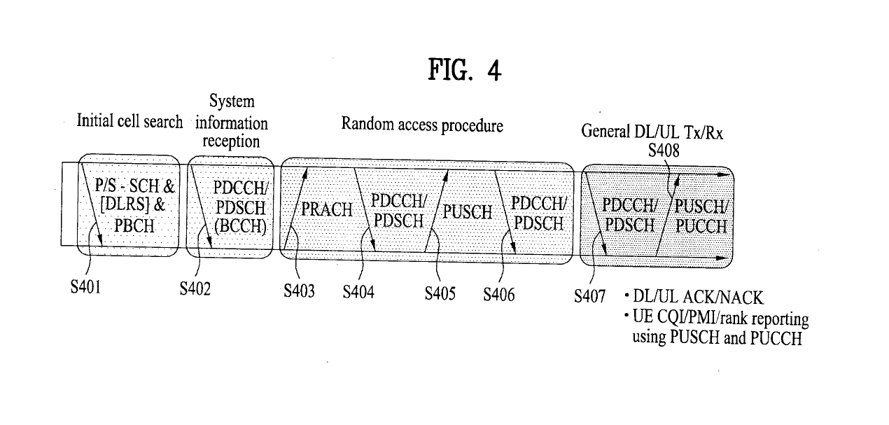

FIG. 4 is a diagram showing physical channels used in a 3GPP system and a general signal transmission method using the same.

When a UE is powered on or enters a new cell, the UE performs an initial cell search operation such as synchronization with an eNB (S401). To this end, the UE may receive a primary synchronization channel (P-SCH) and a secondary synchronization channel (S-SCH) from the eNB to perform synchronization with the eNB and acquire information such as a cell ID. Then, the UE may receive a physical broadcast channel from the eNB to acquire broadcast information in the cell. During the initial cell search operation, the UE may receive a downlink reference signal (DL RS) so as to confirm a downlink channel state.

After the initial cell search operation, the UE may receive a physical downlink control channel (PDCCH) and a physical downlink control channel (PDSCH) based on information included in the PDCCH to acquire more detailed system information (S402).

When the UE initially accesses the eNB or has no radio resources for signal transmission, the UE may perform a random access procedure (RACH) with respect to the eNB (steps S403 to S406). To this end, the UE may transmit a specific sequence as a preamble through a physical random access channel (PRACH) (S403) and receive a response message to the preamble through the PDCCH and the PDSCH corresponding thereto (S404). In the case of contention-based RACH, the UE may further perform a contention resolution procedure.

After the above procedure, the UE may receive PDCCH/PDSCH from the eNB (S407) and may transmit a physical uplink shared channel (PUSCH)/physical uplink control channel (PUCCH) to the eNB (S408), which is a general uplink/downlink signal transmission procedure. Particularly, the UE receives downlink control information (DCI) through the PDCCH. Here, the DCI includes control information such as resource allocation information for the UE. Different DCI formats are defined according to different usages of DCI.

Control information transmitted from the UE to the eNB in uplink or transmitted from the eNB to the UE in downlink includes a downlink/uplink acknowledge/negative acknowledge (ACK/NACK) signal, a channel quality indicator (CQI), a precoding matrix index (PMI), a rank indicator (RI), and the like. In the case of the 3GPP LTE system, the UE may transmit the control information such as CQI/PMI/RI through the PUSCH and/or the PUCCH.

FIG. 5 is a diagram showing the structure of a radio frame used in an LTE system.

Referring to FIG. 5, the radio frame has a length of 10 ms (327200×Ts) and is divided into 10 subframes having the same size. Each of the subframes has a length of 1 ms and includes two slots. Each of the slots has a length of 0.5 ms (15360×Ts). Ts denotes a sampling time, and is represented by Ts=1/(15 kHz×2048)=3.2552×10-8 (about 33 ns). Each of the slots includes a plurality of OFDM symbols in a time domain and a plurality of Resource Blocks (RBs) in a frequency domain. In the LTE system, one RB includes 12 subcarriers×7 (or 6) OFDM symbols. A transmission time interval (TTI) that is a unit time for transmission of data may be determined in units of one or more subframes. The structure of the radio frame is purely exemplary and thus the number of subframes included in the radio frame, the number of slots included in a subframe, or the number of OFDM symbols included in a slot may be changed in various ways.

Hereinafter, an RRC state of a UE and an RRC connection method will be described.

The RRC state indicates whether the RRC layer of the UE is logically connected to the RRC layer of the E-UTRAN. When the RRC connection is established, the UE is in a RRC_CONNECTED state. Otherwise, the UE is in a RRC_IDLE state.

The E-UTRAN can effectively control UEs because it can check the presence of RRC_CONNECTED UEs on a cell basis. On the other hand, the E-UTRAN cannot check the presence of RRC_IDLE UEs on a cell basis and thus a CN manages RRC_IDLE UEs on a TA basis. A TA is an area unit larger than a cell. That is, in order to receive a service such as a voice service or a data service from a cell, the UE needs to transition to the RRC_CONNECTED state.

In particular, when a user initially turns a UE on, the UE first searches for an appropriate cell and camps on the cell in the RRC_IDLE state. The RRC_IDLE UE transitions to the RRC_CONNECTED state by performing an RRC connection establishment procedure only when the RRC_IDLE UE needs to establish an RRC connection. For example, when uplink data transmission is necessary due to call connection attempt of a user or when a response message is transmitted in response to a paging message received from the E-UTRAN, the RRC_IDLE UE needs to be RRC connected to the E-UTRAN.

Hereinafter, a carrier aggregation (CA) scheme of an LTE-A system will be described.

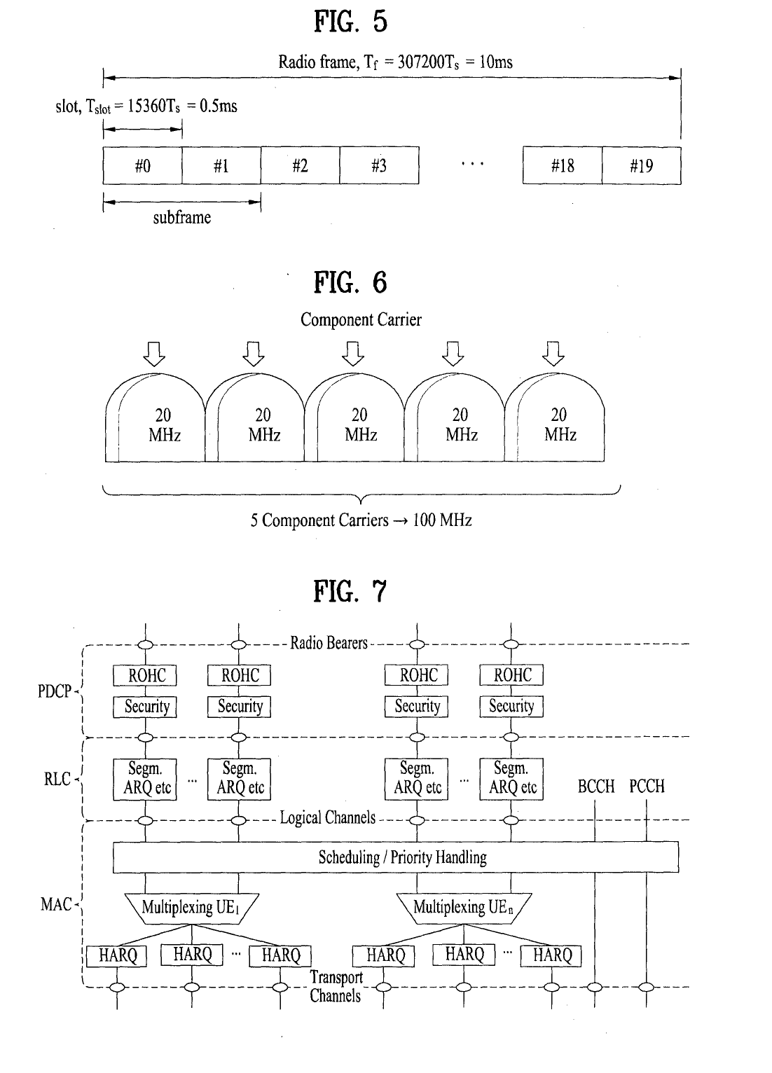

FIG. 6 is a diagram showing the concept of a carrier aggregation scheme of an LTE-A system.

LTE-A technology is a candidate of IMT-advanced technology of international telecommunication union (ITU) and is designed to suit requirements of the IMT-advanced technology of ITU. Accordingly, in LTE-A, in order to satisfy requirements of ITU, bandwidth extension has been discussed, as compared to an existing LTE system. In order to extend bandwidth in the LTE-A system, a carrier in an existing LTE system is defined as a component carrier (CC) and combination and use of up to 5 CCs have been discussed. For reference, a serving cell may be composed of one downlink CC and one uplink CC. Alternatively, the service cell may be composed of one downlink CC. Since the CC may have a maximum bandwidth of 20 MHz as in the LTE system, bandwidth may be maximally extended to up to 100 MHz. Technology for combining and using a plurality of CCs is referred to as CA.

If CA is applied, only one RRC connection is present between a UE and a network. Among a plurality of serving cells configured to be used by a UE, a serving cell for providing security input and NAS layer mobility information for establishment and reestablishment of RRC connection is referred to as a primary serving cell (PCell) and the other cells are referred to as secondary serving cells (SCells).

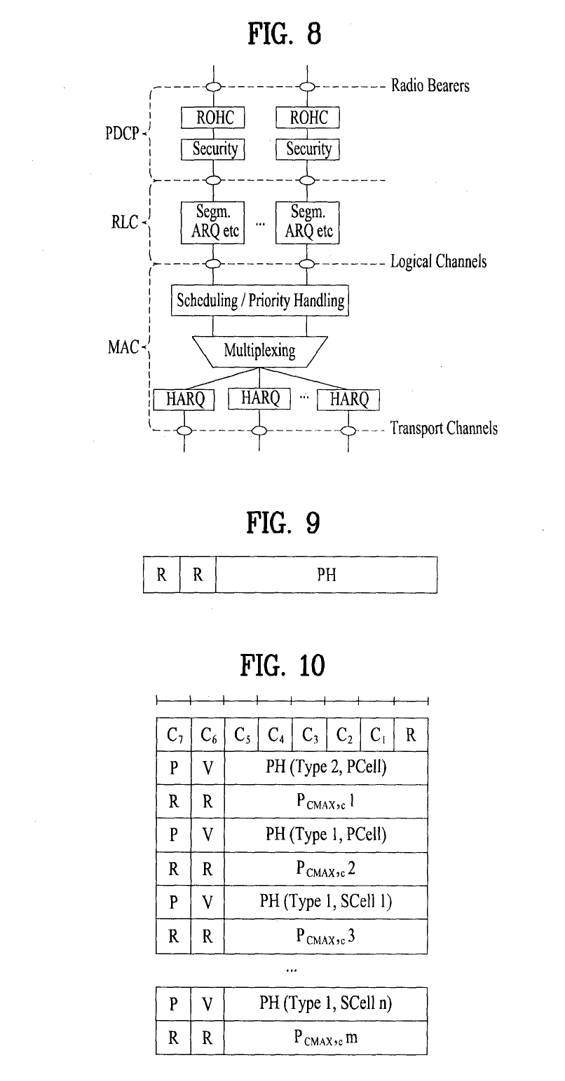

FIGS. 7 and 8 are diagrams respectively showing a second downlink layer structure and a second uplink layer structure if a carrier aggregation scheme is applied.

Referring to FIGS. 7 and 8, the CA scheme has significant influence on an MAC layer of a second layer. For example, in CA, since a plurality of CCs is used and one HARQ entity manages one CC, the MAC layer of the LTE-A system should perform operations related to a plurality of HARQ entities. In addition, since the HARQ entities independently process transport blocks, in CA, a plurality of transport blocks may be transmitted or received at the same time via a plurality of CCs.

Hereinafter, power headroom reporting (PHR) will be described.

In order to transmit data from a UE to an eNB, transmit power should be appropriately controlled. If transmit power is extremely low, the eNB does not receive data and, if transmit power is extremely high, the eNB may receive data from the UE but may not receive data from another UE. Accordingly, the eNB needs to optimize power used for uplink transmission of the UE.

The eNB should acquire necessary information from the UE in order to control the transmit power of the UE. At this time, a power headroom (PHR) is used. The PHR means power which may be further used in addition to the current transmit power of the UE. In other words, the PHR means a difference between maximum transmit power and current transmit power of the UE.

The eNB receives a report for the PHR from the UE and determines power to be used for uplink transmission of another UE based on the report. The determined transmit power is expressed by the size of the resource block and a modulation and coding scheme (MCS) and is delivered when UL grant is allocated to another UE.

The eNB should appropriately receive the report for the PHR from the UE in order to allocate optimal transmit power to the UE. However, when the UE frequently transmits the PHR, radio resources may be wasted. Therefore, currently, in the LTE system, a PHR trigger condition is determined as follows and the PHR is transmitted as necessary.
If path loss is changed by a reference value dl-PathlossChange after recent PHR transmission,
If a periodicPHR-Timer has expired
If a PHR related parameter is configured or reconfigured

If the PHR is triggered for the above-described reasons, the UE transmits the PHR via the following process if newly received UL grant is present in a TTI.

1) A power headroom value is received from a physical layer.

2) A PHR MAC control element (CE) is generated and transmitted based on the power headroom value.

3) A periodicPHR-Timer restrarts.

As described above, the UE transmits the PHR via the PHR MAC CE. In a UL-SCH, a logical channel ID (LCID) value for the PHR MAC CE is allocated (LCID=11010).

FIG. 9 is a diagram showing the format of a PHR MAC control element.

Referring to FIG. 9, R denotes a reserved bit and an actual power headroom value is reported via a PH field. Currently, in the LTE system, 6 bits are used in the PH field to indicate a total of 64 power headroom levels.

Hereinafter, Extended Power Headroom will be described.

In case in which a plurality of serving cells is configured and a UE using a CA function reports a PHR to an eNB, the following operations are performed.

i) The UE reports PH values of all activated serving cells to the eNB.

ii) In calculation of the PH of each serving cell, the UE calculates a maximum output value of the UE for the corresponding serving cell and calculates the output value obtained by subtracting the output value currently used in the corresponding serving cell from the maximum output value as the PH value.

iii) If the PHR is triggered and UL grant is allocated to only some serving cells, the serving cells calculate PH values using the allocated UL grant and the remaining serving cells calculate PH values using a predefined reference format.

iv) The maximum output value of the UE for the serving cell excludes a power reduction value applied to the UE within the MPR value according to implementation of the UE.

v) When the maximum output value of the UE is calculated, since different values may be applied to the UE within the MPR value according to implementation of the UE, the UE further includes the maximum output value P_{CMAX,c} excluding power reduction in the PHR and transmits the PHR, in order to more accurately report the power headroom to the eNB.

FIG. 10 is a diagram showing an extended PHR MAC CE format.

In FIG. 10, a Ci field is mapped to an index of a SCell configured for a UE. If this field is set to 1, this indicates that the PH of the SCell is present. In addition, a V field indicates whether the PH of the corresponding serving cell is calculated using actually allocated UL grant or using a predetermined format. If the V field is set to 1, this indicates that the PH is calculated using the predetermined format.

In addition, a P field indicates whether P_{CMAX,c} has been changed by forcibly reducing LTE transmit power at the UE if LTE transmission and another radio access technology (RAT) transmission simultaneously occur. If the P field is set to 1, this indicates that P_{CMAX,c} has been changed due to another RAT transmission.

A P_{CMAX,c} field indicates a maximum output value of the UE used when the UE calculates the PH and an R field is a reserved field.

Finally, a PH field indicates a power headroom level. Here, the PH may be divided into Type 1 PH and Type 2 PH. Type 1 PH is equal to a conventional PH and indicates a power headroom considering the power of a PUSCH. Type 2 PH indicates a power headroom considering the power of a PUSCH and the power of a PUCCH if simultaneous transmission of the PUCCH and the PUSCH is set with respect to the UE.

Next, maximum power reduction (MPR) will be described.

A high-order modulation scheme such as 16QAM used in an LTE system and a large number of allocated resource blocks increase a difference between average power and maximum power, deteriorating power efficiency and causing problems in design of a power amplifier of the UE. Accordingly, in the LTE system, for power reduction of the UE, a lowest limit value of maximum output power is defined and is referred to as MPR. That is, the UE may reduce power within an allowable MPR value and transmit a signal to an eNB. Table 1 shows an MPR value according to the modulation scheme defined in the LTE system and the number of resource blocks.

TABLE 1

| | Channel bandwidth/Transmission | | | | | | |
|---|---|---|---|---|---|---|---|
| | bandwidth configuration (RB) | | | | | | |
| | 1.4 | 3.0 | 5 | 10 | 15 | 20 | MPR |
| Modulation | MHz | MHz | MHz | MHz | MHz | MHz | (dB) |
| QPSK | >5 | >4 | >8 | >12 | >16 | >18 | <1 |
| 16 QAM | <5 | <4 | <8 | <12 | <16 | <18 | <1 |
| 16 QAM | >5 | >4 | >8 | >12 | >16 | >18 | <2 |

Next, a relationship between an MPR and a PHR will be described.

As described above, the UE may inform the eNB of power headroom of the UE. The power headroom is calculated by subtracting currently used transmit power from maximum output power of the UE, to which power reduction is applied, and then considering other elements such as path loss. The currently used transmit power is calculated using the resource block of the UL grant and the modulation scheme.

As described above, the UE may arbitrarily reduce power within the MPR value according to implementation of the UE. That is, this indicates that the eNB is not aware of a power reduction value applied to the UE and may not accurately determine the maximum output power of the UE. Accordingly, the eNB may derive the power reduction value of the UE via the PHR according to the transmit power allocated to the UE. That is, the eNB may record the power reduction value of the UE according to the allocated transmit power, that is, the resource block and the modulation scheme, and use the power reduction value to manage the transmit power to be allocated to the UE later.

If the UE is not configured with extendedPHR or if the UE is configured with extendedPHR but not configured with simultaneousPUCCH-PUSCH, the practical UE implementation would be that when there is a triggered PHR and the UE has an UL grant in subframe n:
UE MAC pre-constructs a MAC PDU including the (extended) PHR MAC CE in subframe n+2,
UE MAC obtains the values of the power headroom and corresponding P_{CMAX,c} from the physical layer in subframe n+3,
UE MAC inserts the values to the (extended) PHR MAC CE in subframe n+3,
UE transmits the MAC PDU in subframe n+4.

Following similar UE implementation, if the UE is configured with extendedPHR and simultaneousPUCCH-PUSCH, the possible UE implementation would be that when there is a triggered PIN and the UE has an UL grant in subframe n:
UE MAC pre-constructs a MAC PDU including the extended PHR MAC CE in subframe n+2. The size of the extended PHR MAC CE is calculated with assumption that the PUCCH reference format is not used.
UE MAC obtains the values of the power headroom and corresponding P_{CMAX,c} from the physical layer in subframe n+3, Also, the physical layer indicates whether there is an UL PUCCH in subframe n+4.
If the physical layer indicates that there is no UL PUCCH in subframe n+4 (i.e., use of the PUCCH reference format), UE MAC re-constructs the MAC PDU so that the extended PHR MAC CE does not include the P_{CMAX,c} for Type 2 PH in subframe n+3. And UE MAC inserts the values to the (extended) PHR MAC CE in subframe n+3. Next, UE transmits the MAC PDU in subframe n+4.

However, when the MAC PDU pre-constructed in subframe n+2 is re-constructed in subframe n+3 (as illustrated above), there may be a time constraint on UE implementation because the pre-constructed MAC PDU may be largely reformatted at the last minute.

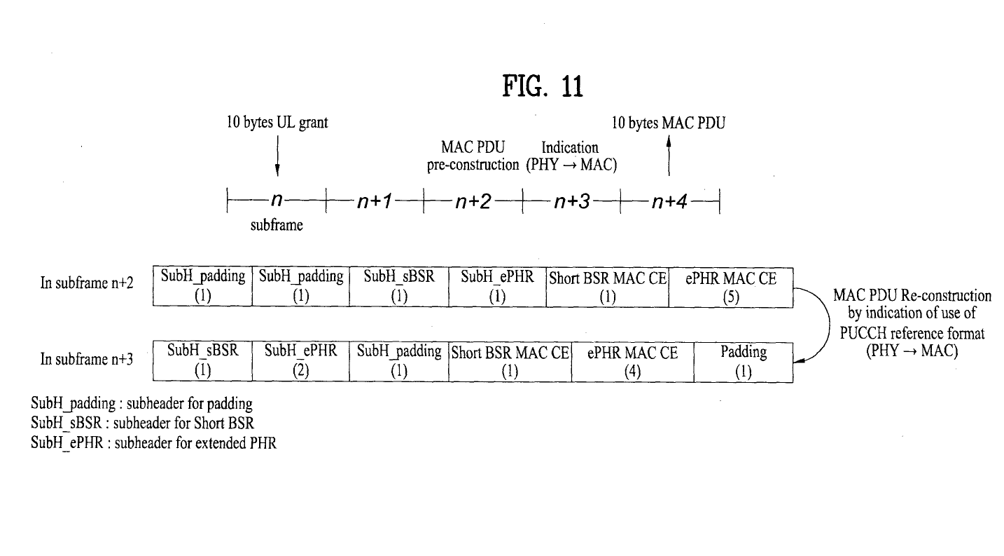

FIG. 11 shows an example about why the pre-constructed MAC PDU needs to be reformatted.

Referring to FIG. 11, if the UE has 10 bytes UL grant and there are the triggered BSR (Buffer Status Report) and PHR, the UE pre-constructs the MAC PDU in subframe n+2. The extended MAC CE (5 bytes) in the MAC PDU consists of Cᵢ field (1)+Type 2 PH & P_{CMAX,c} (2)+Type 1 PH & P_{CMAX,c} (2).

Then, because the physical layer indicates that the PUCCH reference format is used, the UE re-constructs the MAC PDU in subframe n+3. The extended MAC CE in the MAC PDU (4 bytes) consists of Cᵢ field (1)+Type 2 PH (1)+Type 1 PH & P_{CMAX,c} (2).

Upon changing the size of the extended PHR MAC CE, the pre-constructed MAC PDU needs to be reformatted so that the two bytes padding at the beginning of the MAC PDU is changed to one byte subheader for padding and one byte padding bits, and one byte subheader for the extended PHR is changed to two bytes subheader with L field.

Although PUCCH transmissions for HARQ feedback are foreseen in subframe n+2 by the MAC layer according to reception of the DL assignment, other PUCCH transmissions for CSI and SR are not foreseeable by the MAC layer because the configuration for CSI and SR is invisible to the MAC layer in practical UE implementation. Also, re-constructing the MAC PDU at the last minute couldn't be easily implemented and making all PUCCH transmissions visible to the MAC layer would change the legacy UE implementation.

According to the present application, when the UE generates an extended PHR MAC CE, if the PUCCH reference format is used (i.e., if the PUCCH transmission does not occur), the UE replaces the P_{CMAX,c} field for Type 2 or the octet containing the P_{CMAX,c} field for Type 2 PH with the padding. Furthermore, the V field corresponding to the Type 2 PH indicates whether there is padding in the extended PHR MAC CE. Here, V=1 indicates that there is padding in the extended PHR MAC CE.

More specifically, when the UE is configured with extendedPHR and simultaneousPUCCH-PUSCH, if a PHR is triggered, the UE has a valid UL grant for subfrane n to accommodate the extended PHR MAC CE, and the UE has no PUCCH transmission in subfram n, the UE generates the extended PHR MAC CE.

When generating the extended PHR MAC CE, the UE replaces the P_{CMAX,c} field for Type 2 PH or the octet containing P_{CMAX,c} field for Type 2 PH with the padding. In this case, the padding may have any values. Further, the UE sets V field for Type 2 PH to “1”, and transmits the MAC PDU including the extended PHR MAC CE including padding.

Hereinafter, it is discribed a new extended PHR format in case of that the PUCCH reference foramt is used (i.e., the PUCCH transmission does not occur). There are four alternatives for the new extended PHR formats.

A) Extended PHR Format 1

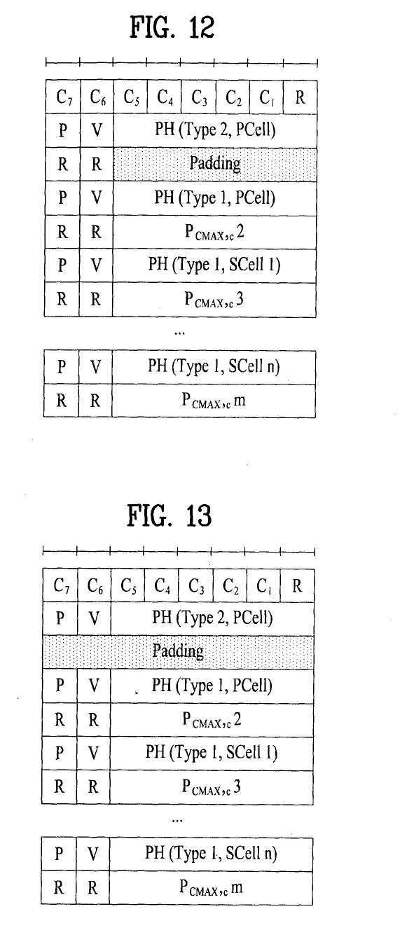

FIG. 12 shows an example of a new extended PHR format 1.

Referring to FIG. 12, when the PUCCH reference format is used, the UE replaces the P_{CMAX,c} with the padding and locates the padding at the same position as the P_{CMAX,c} field for Type 2.

In this case, for Type 2 PH, V=1 indicates the presence of the octet containing the padding. If the eNB receives the extended PHR and the extened PHR indicates the V=1 for Type 2 PH, the eNB interprets that the octet containing the Type 2 PH field is included and is followed by an octet containing the padding.

B) Extended PHR Format 2

FIG. 13 shows an example of a new extended PHR format 2.

Referring to FIG. 13, when the PUCCH reference format is used, the UE replaces the octet containing the P_{CMAX,c} with the padding and locates the padding at the same position as the octect containing the P_{CMAX,c} field for Type 2.

In this case, for Type 2 PH, V=1 indicates the presence of one octet padding. If the eNB receives the extended PHR and the extened PHR indicates the V=1 for Type 2 PH, the eNB interprets that the octet containing the Type 2 PH field is included and is followed by one octet padding.

C) Extended PHR Format 3

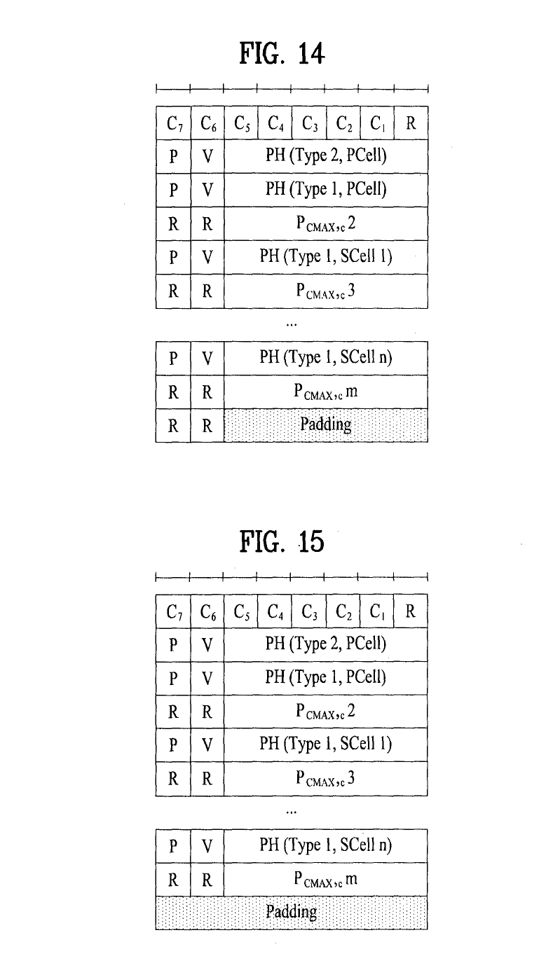

FIG. 14 shows an example of a new extended PHR format 3.

Referring to FIG. 14, with when the PUCCH reference format is used, the UE replaces the P_{CMAX,c} for Type 2 with the padding and locates octet containing the padding at the end of the extended PHR MAC CE as in figure c. In this case, for Type 2 PH, V=1 indicates the presence of one octet containing the padding at the end of the extended PHR MAC CE.

If the eNB receives the extended PHR and the extened PHR indicates the V=1 for Type 2 PH, the eNB interprets that the octet containing the Type 2 PH field is included and is followed by the octet containing the Type 1 PH(s) and the associated the P_{CMAX,c} if reported, and the octet containing the padding is located at the end of the extended PHR MAC CE.

C) Extended PHR Format 4

FIG. 15 shows an example of a new extended PHR format 4.

Referring to FIG. 15, when the PUCCH reference format is used, the UE replaces the octet containing the P_{CMAX,c} with the padding and locates one octet padding at the end of the extended PHR MAC CE as in figure d. In this case, for Type 2 PH, V=1 indicates the presence of one octet padding at the end of the extended PHR MAC CE.

If the eNB receives the extended PHR and the extened PHR indicates the V=1 for Type 2 PH, the eNB interprets that the octet containing the Type 2 PH field is included and is followed by the octet containing the Type 1 PH(s) and the associated the P_{CMAX,c} if reported, and one octet padding is located at the end of the extended PHR MAC CE.

In the present invention, if P_{CMAX,C} for Type 2 PH is omitted while the UE generates the extended PHR MAC CE having a variable length, since a problem occurs in generation of the MAC PDU of the UE, a method of adding the padding instead of the omitted Type 2 PH is proposed. Accordingly, it is possible to solve the problem occurring in generation of the MAC PDU when the UE generates the PHR MAC CE.

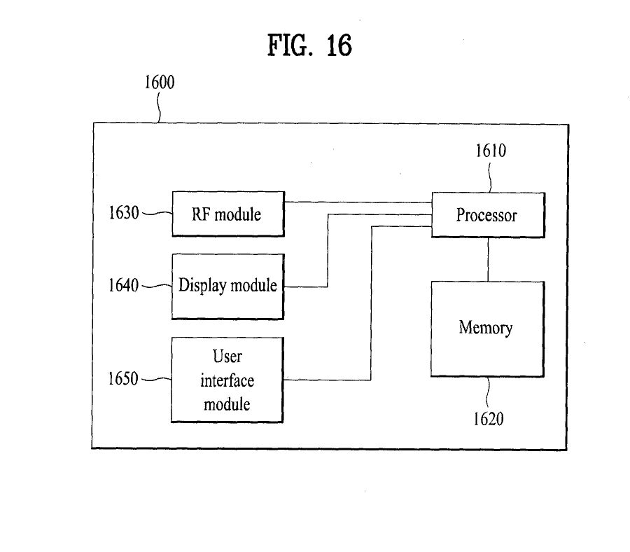

FIG. 16 is a block diagram illustrating a communication apparatus in accordance with an embodiment of the present invention.

Referring to FIG. 16, a communication device 1600 includes a processor 1610, a memory 1620, an Radio Frequency (RF) module 1630, a display module 1640, and a user interface module 1650.

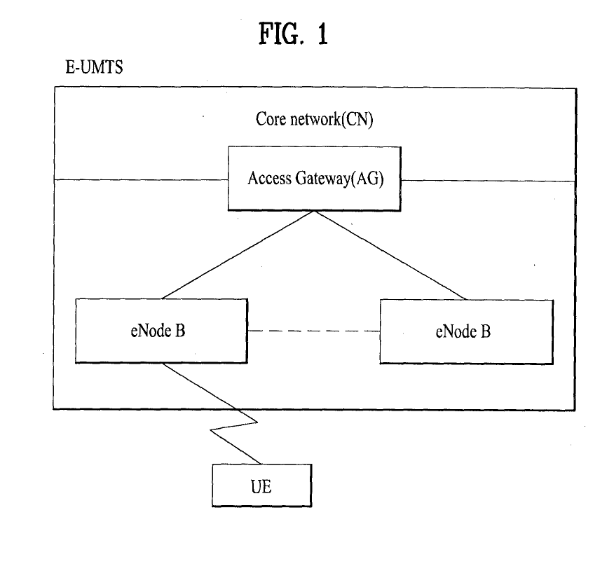

The communication device 1600 is illustrated for convenience of the description and some modules may be omitted. Moreover, the communication device 1600 may further include necessary modules. Some modules of the communication device 1600 may be further divided into sub-modules. The processor 1600 is configured to perform operations according to the embodiments of the present invention exemplarily described with reference to the figures. Specifically, for the detailed operations of the processor 1600, reference may be made to the contents described with reference to FIGS. 1 to 15.

The memory 1620 is connected to the processor 1610 and stores operating systems, applications, program code, data, and the like. The RF module 1630 is connected to the processor 1610 and performs a function of converting a baseband signal into a radio signal or converting a radio signal into a baseband signal. For this, the RF module 1630 performs analog conversion, amplification, filtering, and frequency upconversion or inverse processes thereof. The display module 1640 is connected to the processor 1610 and displays various types of information. The display module 1640 may include, but is not limited to, a well-known element such as a Liquid Crystal Display (LCD), a Light Emitting Diode (LED), or an Organic Light Emitting Diode (OLED). The user interface module 1650 is connected to the processor 1610 and may include a combination of well-known user interfaces such as a keypad and a touchscreen.

The above-described embodiments are combinations of elements and features of the present invention in a predetermined manner. Each of the elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. In the appended claims, it will be apparent that claims that are not explicitly dependent on each other can be combined to provide an embodiment or new claims can be added through amendment after the application is filed.

The embodiments according to the present invention can be implemented by various means, for example, hardware, firmware, software, or combinations thereof. In the case of a hardware configuration, the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In the case of a firmware or software configuration, the method according to the embodiments of the present invention may be implemented by a type of a module, a procedure, or a function, which performs functions or operations described above. For example, software code may be stored in a memory unit and then may be executed by a processor. The memory unit may be located inside or outside the processor to transmit and receive data to and from the processor through various well-known means.

The present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents and all changes coming within the meaning and equivalency range of the appended claims are intended to be embraced therein.

### INDUSTRIAL APPLICABILITY

While the above-described method for transmitting power headroom report to a network at a user equipment in a wireless communication system and an apparatus therefor has been described centering on an example applied to the 3GPP LTE system, the present invention is applicable to a variety of wireless communication systems in addition to the 3GPP LTE system.

1. A method for processing a signal at a user equipment in a wireless communication system, the method comprising:
constructing a PHR (Power Headroom Report) MAC (Medium Access Control) control element for at least one cell;
reconstructing the PHR MAC control element by replacing information on the transmission power of the at least one cell with padding bits, if an indication indicating that a transmission of the at least one cell does not occur is received from a network; and
transmitting the PHR MAC control element to the network.

2. The method of claim 1, wherein the reconstructed PHR MAC control element includes a field indicating that the information on the transmission power of the at least one cell is replaced with the padding bits.

3. The method of claim 1, wherein a size of the padding bits is same with a size of the information on the transmission power of the at least one cell.

4. The method of claim 1, wherein a position of the padding bits is same with a position of the information on the transmission power of the at least one cell in the PHR MAC control element.

5. The method of claim 1, wherein the padding bits are located at an end of the PHR MAC control element.

6. The method of claim 1, wherein reconstructing the PHR MAC control element comprises replacing at least one field included in a octet comprising the information on the transmission power of the at least one cell with the padding bits.

7. The method of claim 6, wherein the reconstructed PHR MAC control element includes a field indicating that the octet is replaced with the padding bits.

8. The method of claim 6, wherein the at least one field comprises reserved bits.

9. The method of claim 1, wherein the information on the transmission power of the at least one cell is a field indicating a maximum output power of the at least one cell.

10. The method of claim 1, wherein a size of the PHR MAC control element is maintained after reconstructing.
